(19) United States
(12) Patent Application Publication
(10) Pub. No.: US 2017/0106542 A1
(43) Pub. Date: Apr. 20, 2017

(54) ROBOT AND METHOD OF CONTROLLING THEREOF

(71) Applicants: Amit Wolf, Los Angeles, CA (US); Lior Wolf, Herzliya (IL)

(72) Inventors: Amit Wolf, Los Angeles, CA (US); Lior Wolf, Herzliya (IL)

(21) Appl. No.: 15/293,528

(22) Filed: Oct. 14, 2016

Related U.S. Application Data
(60) Provisional application No. 62/242,886, filed on Oct. 16, 2015.

(51) Int. Cl. B25J 13/08; G06N 3/04; G06N 3/08; B25J 9/16

(52) U.S. Cl. CPC B25J 13/085; B25J 9/1664; G06N 3/0454; G06N 3/08; G05B 2219/40519; G05B 2219/39373

(57) ABSTRACT

A robot having at least one member having at least one controllably actuable articulation, said articulation having at least one torque sensor for providing a torque signal indicative of a torque applied to the articulation, and one angle sensor for providing an angle signal indicative of an angle of actuation of the articulation; the robot further comprising:
a controller for controlling said at least one controllably actuable articulation;
a first neural network arranged for receiving the torque and angle signals and arranged for providing to the controller a force signal indicating that an external force is applied to said at least one member:
a second neural network arranged for receiving the torque and angle signals and arranged for providing to the controller a direction signal indicating the direction along which said external force is applied to said at least one member.

The present application claims priority of U.S. provisional application No. 62/243038, filed Oct. 16, 2015, and entitled “A ROBOT AND METHOD OF CONTROLLING THEREOF” which is hereby incorporated by reference it in its entirety.

### BACKGROUND

Field

the present disclosure relates to the field of robots and methods of controlling thereof; in particular a robot capable of lead-through learning and methods of controlling thereof.

Description of the Background Art

Lead-through learning underlies the smooth, sweeping, continuous motions of modem robots in many fields: from arc welding to paint spraying to the cinematic camera movement and control of Hollywood's latest creations. Lead-through learning involves a user that manually conducts the robot through an intentioned path, similar to leading someone by the hand Conventionally, the method uses a syntaxeur—a mock-up proxy of the manipulator—that carries comparable joint position sensors but none of the actuators. This limitation of the need for a secondary manipulator towards programming has been increasingly overcome by soft robotics. They are also termed compliant robotics. These soft-jointed manipulators employ the mechanical elasticity of spring series elastic actuators (SEAS) towards environmental compliance and adoptability. The seven axes Baxter (by Rethink Robotics), Universal Robots' UR5 and UR10, and Hocoma's Lokomat exoskeleton, are a few examples of current day SEA, with lead-through applications ranging from straightforward programming of simple, everyday tasks, to industrial CoBoting with precision involving repeatability levels of up to 100 microns, to medical rehabilitation of limbs (see E. Eitel, “The rise of soft robots and the actuators that drive them,” Machine Design, 2013 (hereafter [1])).

Soft robotics is making its chief strides in solving problems of human-robot interaction as well as addressing the dynamic environments of material production. At the same time, SEAs entail a significant reduction in both repeatability and payload with respect to rigid joint robotics. The powers and limitations of SEAs are balanced by a new breed of joints offering doubly laid and opposing actuators. These variable-stiffness actuators (VSAs) can be seen to regain at least some of the performance benchmarks set by rigid joint industrial robotics [1]. However, these technologies are capital-intensive, requiring the incorporation of new robots.

It was tried to implement lead-through learning using collision detection systems. Some known collision-detection systems rely on external sensing mechanisms. For example, in D. Ebert and D. Henrich, “Safe human-robot-cooperation: Imagebased collision detection for industrial robots,” in IEEE/RSJ Int Conf. on Intelligent Robots and Systems, 2002, pp. 239-244 (hereafter [2]), a camera captures the manipulator as it operates and uses image analysis techniques to detect a collision state. Other works aim for a simpler collision detection system, which does not require external aids. These typically use only the available readings such as link position, velocity and torque, and apply rigid-robot dynamic equations (see R. Ortega and M. W. Spong, “Adaptive motion control of rigid robots: A tutorial,” Automatica, vol. 25, no. 6, pp. 877-888, 1989, hereafter [3]) to detect differences between sensed and actual torque. A discrepancy indicates the existence of an external force.

An example of such a scheme for collision detection is S. Morinaga and K. Kosuge, “Collision detection system for manipulator based on adaptive impedance control law,” in IEEE Int. Conf. on Robotics and Automation, 2003, pp. 1080-1085 (hereafter [4]). Using the system's dynamic equations, the reference torque value is calculated based on the expected position, velocity and other parameters and compared to the actual torque signal which is calculated based on actual sensor readings. The assumption at the base of this work is that in absence of external interference, the actual and control torques should be very similar. A significant difference between the two triggers a collision report and some control tactic is being deployed. Similarly, in A. D. Luca and R. Mattone, “Sensorless robot collision detection and hybrid force/motion control,” in IEEE Int. Conf. on Robotics and Automation, 2005, pp. 1011-1016 (hereafter [5]); A. D. Luca, A. Albu-Schäffer, S. Haddadin, and G. Hirzinger, “Collision detection and safe reaction with the dlr-iii lightweight robot arm,” in IEEE/RSJ Int. Conf. on Intelligent Robots and Systems, 2006, pp. 1623-1630 (hereafter [6]); and S. Haddadin, A. Albu-Schäffer, A. De Luca, and G. Hirzinger, “Collision detection and reaction: A contribution to safe physical human-robot interaction,” in IEEE/RSJ International Conference on Intelligent Robots and Systems (IROS), 2008, pp. 3356-3363 (hereafter [7]); a residual-based method is used for collision detection and avoidance.

In addition to the detection of a collision state, an estimation of the external force acting on the robot links can be estimated, as shown in A. D. Luca and F. Flacco, “Integrated control for pHRI: Collision avoidance, detection, reaction and collaboration,” in IEEE Int. Conf. on Biomedical Robotics and Biomechatronics, 2012, pp. 288-295 (hereafter [8]). In a more recent work (E. Magrini, F. Flacco, and A. De Luca, “Estimation of contact forces using a virtual force sensor,” in IEEE/RSJ International Conference on Intelligent Robots and and Systems, 2014, pp. 2126-2133, hereafter [9]), the force estimation is augmented with an external Kinect sensor. This 3D video sensor helps in determining the exact contact point along the link on which the external interference is detected.

The above works require inertia parameters, such as link mass, for calculating the dynamics of the manipulator system. Some works aim to extract to the exact location of interference. The work of A. Petrovskaya, J. Park, and O. Khatib, “Probabilistic estimation of whole body contacts for multi-contact robot control,” in IEEE Int. Conf. on Robotics and Automation, 2007, pp. 568-573 (hereafter [10]) uses a probabilistic approach in order to estimate where contact occurs. In contrast, in A. D. Prete, L. Natale, F. Nori, and G. Metta, “Contact force estimations using tactile sensors and force/torque sensors,” in Human Robot Interaction, 2012 (hereafter [11]) a tactile sensor network is used in order to estimate the contact forces.

A recent work (A. Stolt, M. Linderoth, A. Robertsson, and R. Johansson, “Detection of contact force transients in robotic assembly,” in IEEE International Conference on Robotics and Automation (ICRA), 2015, pp. 962-968; hereafter [12]) discloses Machine Learning classifiers trained on particular tasks, e.g., to detect events where the end effector reaches a barrier. Contrasting these results with those obtained through the conventional use of predefined torque thresholds for triggering identical state transitions, the research finds clear advantages towards the former in terms of execution speeds. In essence, the work demonstrates that Machine Learning, based on torque readings, can be applied with relative success. Since it is intentioned on per-assembly-task training, the scope of work is constrained to controlled and repetitive tasks.

Position and torque data have been used to feed the active compliance software at the base of some light-weight robots. For example, the DLR-KUKA Lightweight Robot and the DLR-HIT-Schunk Hand, obtain soft behaviors with an integrated approach that seamlessly combines software-based compliance, variable link stiffness, and joint mechanics (see A. Albu-Schäffer, O. Eiberger, M. Grebenstein, S. Haddadin, C. Ott, T. Wimbock, S. Wolf, and G. Hirzinger, “Soft robotics: From torque feedback controlled lightweight robots to intrinsically compliant systems,” in International Conference on Control Automation and Systems (ICCAS), 2010, hereafter [13]). These methods were not shown to be appropriate for heavy-weight, high payload and/or precision driven applications.

A software method for registering and acting upon external forces, SoftMove, by ABB Robotics, is of special interest (see “SoftMove: cartesian soft servo” https://library.e.abb.com/public/74f4e5050f189f82c12573f00054efd0/Data, accessed: Sep. 13, 2015. ABB, Västerås, Sweden. 2008; hereafter [14]). Forgoing mechanical compliance add-ons and related investment costs, the software virtualizes soft robotics behaviors rather than physically altering the rigid joint configuration. Detection is torque based, with torque limits set for one distinct robot axis at a time.

Thus conceived, the compliance is constrained to one Cartesian direction: detecting resistance along the vector direction, the manipulator's trajectory is terminated at the surface of the obstruction. Still, while ABB Robotics offers a software solution that softens the rigid joints of ABB manipulators without losing its rigid joint performance values, the setup is limited to one Cartesian direction, for which the original stiffness is varied.

Deep neural networks are becoming increasingly popular in the field of robotics. Early use of neural networks in the field can be seen in T. D. Sanger, “Neural network learning control of robot manipulators using gradually increasing task difficulty,” IEEE Transactions on Robotics and Automation, vol. 10, no. 3, pp. 323-333, 1994 (hereafter [15]), which uses neural networks in order to learn to follow a pre-defined trajectory that was created by an unknown set of control commands. In recent years, Convolutional Neural Networks (CNNs) have been shown to perform very well in various image-processing tasks. Naturally, we can see CNN-based systems appear in robotic tasks where some image input is present. For example, the systems shown in I. Lenz, H. Lee, and A. Saxena, “Deep learning for detecting robotic grasps,” The International Journal of Robotics Research, vol. 34, no. 4-5, pp. 705-724, 2015 (hereafter [16]) and J. Redmon and A. Angelova, “Real-time grasp detection using convolutional neural networks,” arXiv:1412.3128, Tech. Rep., 2014 (hereafter [17]) use CNNs for detecting optimal grasping locations for a robotic gripper given an image of an object and its surroundings.

Another interesting work involving CNN can be found in S. Levine, C. Finn, T. Darrell, and P. Abbeel, “End-to-end training of deep visuomotor policies.” arXiv:1504.00702, Tech. Rep., 2015 (hereafter [18]). In this work, a robot is trained end-to-end to perform a particular task via a visual-motor interface. Live images of the robot and the manipulated objects are fed into a CNN that produces the motor signals needed for completing the task. The training is done in a reinforcement learning setting. In M. Giorelli, F. Renda, G. Ferri, and C. Laschi, “A feed-forward neural network learning the inverse kinetics of a soft cable-driven manipulator moving in three-dimensional space,” in IEEE/RSJ International Conference on Intelligent Robots and Systems (IROS), 2013, pp. 5033-5039 (hereafter [19]), a feedforward neural network is applied in the field of robot dynamics, in a specific system, where exact mechanical calculations are difficult to obtain. A soft conic manipulator driven by three cables is used. A neural network is trained to obtain seven parameters of the inverse kinematic model that extracts the forces acting on the robot's cables.

There still exists a need for a robot capable of lead-through learning, that is also capable of precision motion and/or of heavy lifting, that is not expensive and simple to implement.

### SUMMARY

An embodiment of the present disclosure differs from the prior art at least because it does not require a priori knowledge of robot dynamics In contrast, in an embodiment of the present disclosure, no external parameters are required and all of the control parameters (the neural network weights) are learned during a training phase.

In the present disclosure, the term “neural network” means for example an electronic artificial neural network, or a set of interconnected artificial “neuron” electronic circuits capable of exchanging messages between each other. The connections between the neurons have numeric weights that can be tuned based on experience, making neural nets adaptive to inputs and capable of learning. A neural network provided for learning a correspondence between a set of operational input signals and a set of operational output signals can comprise a training input. During a training session, the neural network can be fed with training signals comprising the operational input signals and, one the training inputs, the corresponding operational outputs. After a representative quantity of training signals has been fed to the neural network in training mode, the neural network learns the correspondence between the operational input signals and the operational output signals and is ready to provide, in response to operational input signals, the corresponding operational output signals. A neural network can for example be implemented using a dedicated electronic circuit or a specially configured processor.

An embodiment of the present disclosure provides for neural networks that classify user interaction events in which the torque and manipulator positions are flexible, undetermined, and continuously varied, reflecting material production dynamics.

An embodiment of the present disclosure comprises a robot having a plurality of sensors, in particular joint torque and angle sensors, and at least two neural networks receiving the output of said sensors and providing in response a first signal indicative of a force applied to the robot, and a second signal indicative of the direction of said force.

An embodiment of the present disclosure comprises training at least two neural networks arranged for receiving the output of the sensors of a robot, in particular joint torque and angle sensors, to associate the sensor outputs to a first signal indicative of a force applied to the robot, and a second signal indicative of the direction of said force.

An embodiment of the present disclosure comprises controlling a robot having said at least two neural networks to move in the direction indicated by said direction signal when said force signal is present.

An embodiment of the present disclosure comprises having an operator gently guiding the robot by the hand to any desired sequence of positions, and have the robot record said sequence of positions and reproduce it.

An embodiment of the present disclosure comprises a robot having at least one member, said at least one member having at least one controllably actuable articulation, said articulation having at least one torque sensor for providing a torque signal indicative of a torque applied to the articulation, and one angle sensor for providing an angle signal indicative of an angle of actuation of the articulation;

the robot further comprising:

a controller for controlling said at least one controllably actuable articulation;

a first neural network arranged for receiving the torque and angle signals and arranged for providing to the controller a force signal indicating that an external force is applied to said at least one member;

a second neural network arranged for receiving the torque and angle signals and arranged for providing to the controller a direction signal indicating the direction along which said external force is applied to said at least one member.

According to an embodiment of the present disclosure, the robot has a plurality of controllable articulations each controlled by the controller, each articulation comprising an angle sensor and a torque sensor, wherein the first and second neural networks are arranged for receiving the torque and angle signals from all the articulations, and for providing respectively said force signal indicating that an external force is applied to said at least one member and said direction signal indicating the direction along which said external force is applied to said at least one member.

According to an embodiment of the present disclosure, said member comprises a distal end and a proximal end, and the controller is capable of controlling the at least one controllably actuable articulation to move the distal end with respect to the proximal end along a programmable trajectory; and the processor comprises a trajectory change module that processes the force and direction signals from the neural networks to change said programmable trajectory such that the member additionally moves in the direction indicated by the direction signal as long as the force signal is present.

According to an embodiment of the present disclosure, said member comprises a distal end and a proximal end, and the controller is capable of controlling the at least one controllably actuable articulation to move the distal end with respect to the proximal end; and the processor processes the force and direction signals from the neural networks to move the distal end with respect to the proximal end in the direction indicated by the direction signal as long as the force signal is present.

According to an embodiment of the present disclosure, the first neural network comprises a training input; the training input being connected to the output of a force detector; the force detector being attached to said at least one member and being provided for outputting a force detection signal upon detection that an external force is applied to said at least one member.

According to an embodiment of the present disclosure, said force detection signal is Boolean.

According to an embodiment of the present disclosure, the force detector is removably attached to said at least one member.

According to an embodiment of the present disclosure, the second neural network comprises a training input; the training input being connected to the output of a direction detector; the direction detector being attached to said at least one member and being provided for outputting a direction detection signal upon detection of the direction along which said external force is applied to said at least one member.

According to an embodiment of the present disclosure, said direction detection signal is one of a predetermined number of Boolean signals indicating each a predetermined direction of application of said external force relative to the member.

According to an embodiment of the present disclosure, the direction detector is removably attached to said at least one member.

According to an embodiment of the present disclosure, the direction detector comprises one push button associated to each of said predetermined directions, each push button associated to a predetermined direction facing said predetermined direction; wherein the pressing of a push button associated to a predetermined direction produces a direction detection signal associated to said predetermined direction, and wherein the pressing of any push button produces a force detection signal.

According to an embodiment of the present disclosure, said member comprises a distal end and a proximal end and the first and second neural networks additionally use a signal indicating a position of the distal end with respect to the proximal end to generate respectively the force signal and the direction signal.

According to an embodiment of the present disclosure, said member comprises a distal end and a proximal end and the first and second neural networks additionally use a signal indicating a rotation of the distal end with respect to the proximal end to generate respectively the force signal and the direction signal.

According to an embodiment of the present disclosure, said member comprises a distal end and a proximal end and the first and second neural networks additionally use a signal indicating a speed of the distal end with respect to the proximal end to generate respectively the force signal and the direction signal.

An embodiment of the present disclosure relates to a method of controlling a robot having at least one member, said at least one member having at least one controllably actuable articulation, the method comprising:

periodically generating a torque signal indicative of a torque applied to the articulation, and an angle signal indicative of an angle of actuation of the articulation;

with a first neural network receiving the torque and angle signals, generating a force signal indicating that an external force is applied to said at least one member;

with a second neural network receiving the torque and angle signals, generating a direction signal indicating the direction along which said external force is applied to said at least one member; and

modifying a control of said at least one controllably actuable articulation with said force and direction signals.

According to an embodiment of the present disclosure, the robot comprises a plurality of controllable articulations each controlled by the controller;

wherein said periodically generating a torque signal indicative of a torque applied to the articulation, and an angle signal indicative of an angle of actuation of the articulation comprises periodically generating torque signals indicative of the torque applied to each articulation, and angle signals indicative of the angles of actuation of each articulation;

the method further comprising providing all of the torque and angle signals to the first and second neural networks.

According to an embodiment of the present disclosure, said member comprises a distal end and a proximal end, and the method further comprises:

with the controller, controlling the at least one controllably actuable articulation to move the distal end with respect to the proximal end along a programmable trajectory; and

processing the force and direction signals from the neural networks to change said programmable trajectory such that the member additionally moves in the direction indicated by the direction signal.

According to an embodiment of the present disclosure, said member comprises a distal end and a proximal end, and the method further comprises:

with the controller, controlling the at least one controllably actuable articulation to move the distal end with respect to the proximal end along a programmable trajectory; and

processing the force and direction signals from the neural networks to change said programmable trajectory such that the member ceases to move in a direction opposite the direction indicated by the direction signal.

According to an embodiment of the present disclosure, the first neural network comprises a training input and the method further comprises, with a force detector attached to said at least one member, generating a force detection signal upon detection that an external force is applied to said at least one member; and providing said force detection signal to said training input of the first neural network.

According to an embodiment of the present disclosure, said generating a force detection signal comprises generating a Boolean force detection signal.

According to an embodiment of the present disclosure, the second neural network comprises a training input and the method further comprises, with a direction detector attached to said at least one member, generating a direction detection signal upon detection of the direction along which said external force is applied to said at least one member; and providing said direction detection signal to said training input of the second neural network.

According to an embodiment of the present disclosure, said generating a direction detection signal comprises generating one of a predetermined number of Boolean signals indicating each a predetermined direction of application of said external force relative to the member.

According to an embodiment of the present disclosure, said generating a direction detection signal comprises pressing one of a plurality of push buttons associated each to a predetermined direction; and said generating a force detection signal comprises the pressing of any of said push buttons.

According to an embodiment of the present disclosure, said member comprises a distal end and a proximal end and the method further comprises additionally providing to the first and second neural networks a signal indicating a position of the distal end with respect to the proximal end to generate respectively the force signal and the direction signal.

According to an embodiment of the present disclosure, said member comprises a distal end and a proximal end and the method further comprises additionally providing to the first and second neural networks a signal indicating a rotation of the distal end with respect to the proximal end to generate respectively the force signal and the direction signal.

According to an embodiment of the present disclosure, said member comprises a distal end and a proximal end and the method further comprises additionally providing to the first and second neural networks a signal indicating a speed of the distal end with respect to the proximal end to generate respectively the force signal and the direction signal.

A embodiment of the present disclosure comprises a method of training a robot as detailed above, the method comprising an operator moving the distal end of the robot to a sequence of predetermined positions by gently pushing the distal end of the robot until it moves to each predetermined position; commanding the robot to learn each of these predetermined positions, and commanding the robot to move on its own along the sequence of predetermined positions.

### BRIEF DESCRIPTION OF THE DRAWINGS

FIG. 1 illustrates a robot according to an embodiment of the present disclosure.

FIG. 2 illustrates a robot and a training structure according to an embodiment of the present disclosure.

FIG. 3 details a training structure attached to the distal end of the member of a robot according to an embodiment of the present disclosure.

FIG. 4 illustrates six directions X, Y, −X, −Y, Z, −Z indicated by the direction signal according to an embodiment of the present disclosure.

FIG. 5 illustrates an exemplary cloud of random position points to which was moved a training structure according to an embodiment of the present disclosure.

FIG. 6 illustrates an exemplary output of the first neural network according to an embodiment of the present disclosure.

FIG. 7 illustrates a method of controlling a robot according to an embodiment of the present disclosure.

FIG. 8 illustrates an embodiment of the method of FIG. 7.

FIG. 9 illustrates steps that can follow the method illustrated in FIG. 7.

FIG. 10 illustrates steps that can follow the method illustrated in FIG. 7.

FIG. 11 illustrates a method of programming of the first neural network of a robot according to the present disclosure.

FIG. 12 illustrates a method of programming of the second neural network of a robot according to the present disclosure.

FIG. 13 illustrates an embodiment of generating a direction detection signal according to the present disclosure.

FIG. 14 illustrates steps that can follow the method illustrated in FIG. 7.

FIG. 15 illustrates a method of training a robot according to an embodiment of the present disclosure.

### DETAILED DESCRIPTION

The details of preferred embodiments and best mode for carrying out the ideas of the invention will now be presented. It should be understood that it is not necessary to employ all of the details of the preferred embodiments in order to carry out the idea of the invention.

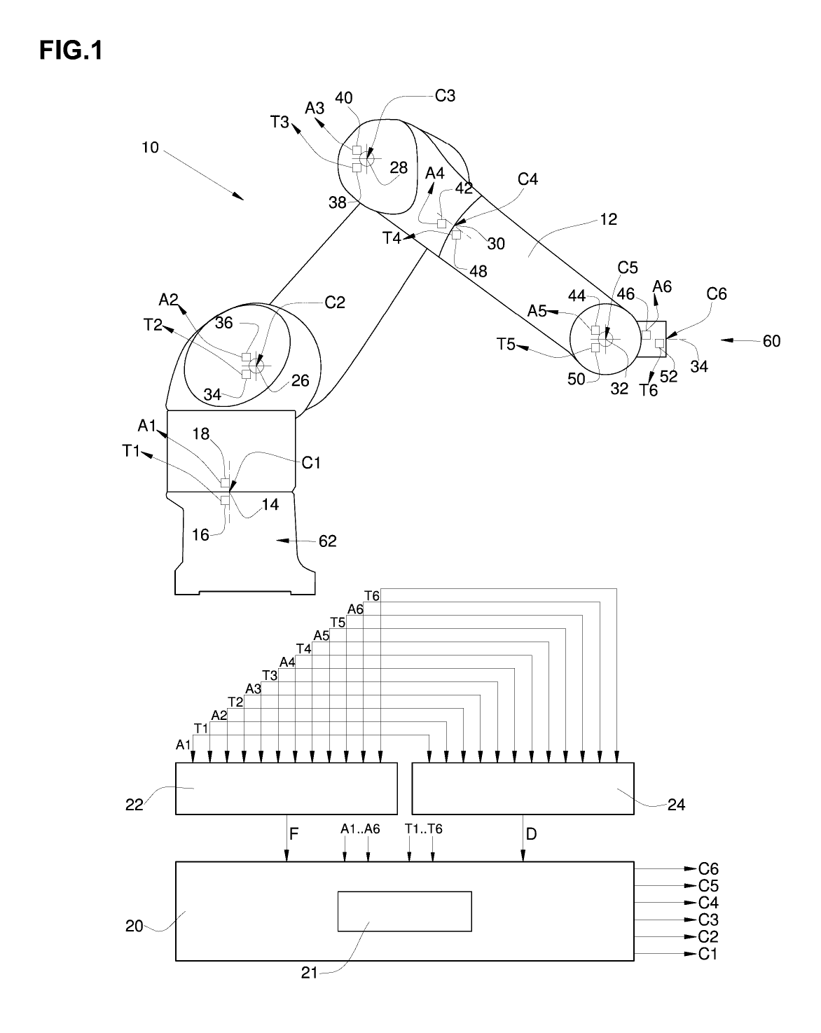

FIG. 1 shows a robot 10 according to an embodiment of the present disclosure, having at least one member 12, said at least one member 12 having at least one controllably actuable articulation 14, said articulation 14 having at least one torque sensor 16 for providing a torque signal T1 indicative of a torque applied to the articulation 14, and one angle sensor 18 for providing an angle signal A1 indicative of an angle of actuation of the articulation 14. According to an embodiment of the present disclosure, the robot 10 further comprises a controller 20 for controlling member 12, and in particular articulation 14, with a control signal C1. The angle of rotation of the articulation 14 can for example be controlled by control signal C1. According to an embodiment of the present disclosure, controller 20 can comprise a control loop comparing angle signal A1 to a desired rotation angle value to produce the control signal C1. According to an embodiment of the present disclosure, a robot having a member 12 with at least an actuable articulation 14 having torque and angle sensors 16, 18 and in particular said at least one controllably actuable articulation 14 and a controller 20 for controlling the articulation can for example be a robot arm known under the commercial name of a Stäubli's medium payload arm (TX90).

According to an embodiment of the present disclosure, robot 10 comprises a first neural network 22 arranged for receiving the torque and angle signals T1, A1 and arranged for providing to the controller 20 a force signal F indicating that an external force is applied to said at least one member 12.

According to an embodiment of the present disclosure, robot 10 comprises a second neural network 24 arranged for receiving the torque and angle signals T1, A1 and arranged for providing to the controller a direction signal D indicating the direction along which said external force is applied to said at least one member 12.

According to an embodiment of the present disclosure, member 12 comprises a plurality of controllable articulations 26, 28, 30, 32, 34 respectively controlled by a control signal C2, C3, C4, C5, C6 from controller 20. Each articulation 26, 28, 30, 32, 34 comprises an angle sensor, respectively 36, 40, 42, 44, 46 and a torque sensor, respectively 34, 38, 48, 50, 52 wherein the first and second neural networks, 22, 24 are arranged for additionally receiving each the torque signals, T2, T3, T4, T5, T6 and angle signals A2, A3, A4, A5, A6 from the articulations 26, 28, 30, 32, 34, to generate respectively said force signal F indicating that an external force is applied to member 12 and said direction signal D indicating the direction along which said external force is applied to member 12.

According to an embodiment of the present disclosure, member 12 comprises a distal end 60 and a proximal end 62, and controller 20 is capable of controlling the actuable articulations 14, 26, 28, 30, 32, 34 to move the distal end 60 with respect to the proximal end 62 along a programmable trajectory. As outlined above, controller 20 can comprise control loops receiving angle and/or torque signals to produce the control signals C1, C2, C3, C4, C5, C6 of articulations 14, 26, 28, 30, 32, 34.

According to an embodiment of the present disclosure, processor 20 comprises a trajectory change module 21 that processes the force and direction signals F, D from the neural networks 22, 24 to change said programmable trajectory by modifying control signals C1, C2, C3 C4, C5, C6 such that the member 12 additionally moves in the direction indicated by the direction signal as long as the force signal is present.

According to an embodiment of the present disclosure, processor 20 processes the force and direction signals F D from the neural networks 22, 24 to initiate a move such that the member 12 moves in the direction indicated by the direction signal as long as the force signal is present. According to an embodiment of the present disclosure, neural networks 22 and 24 are both Multi-Layer Perceptrons (MLPs) classifiers, i.e., fully connected feedforward neural networks.

A robot according to embodiments of the present disclosure allows an operator to move the member to a desired position by gently pushing or pulling the member until the desired position is reached. A robot according to embodiments of the present disclosure is thus particularly suitable for lead-through learning, while being also capable of precision motion and/or of heavy lifting. An operator can move for example the distal end of the robot to a sequence of predetermined positions; command the robot to learn each of these predetermined positions, and then command the robot to move on its own along the sequence of predetermined positions.

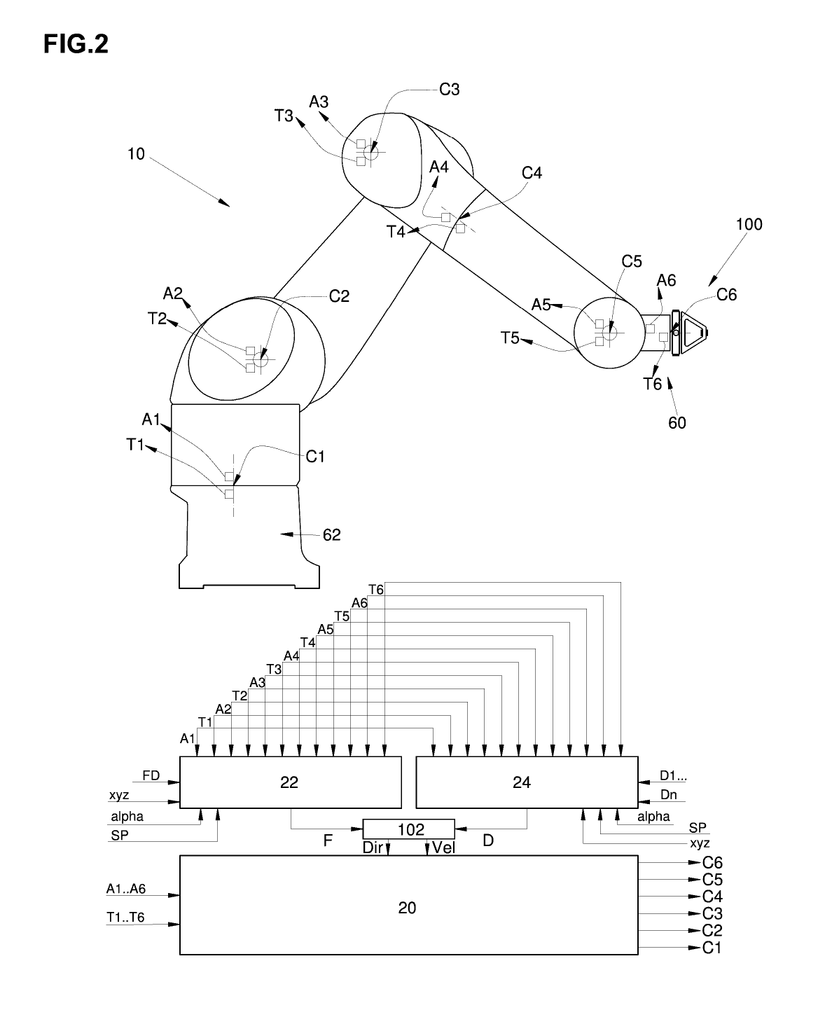

FIG. 2 illustrates a robot 10 having a training structure 100 according to an embodiment of the present disclosure. Robot 10 is as described above in relation with FIG. 1. According to an embodiment of the present disclosure, neural network 22 comprises a training input connected to the output of a force detector of training structure 100. According to an embodiment, training structure 100 is attached to member 12 and is provided for outputting a force detection signal FD upon detection that an external force is applied to it, and consequently to member 12. According to an embodiment of the present disclosure, the force detection signal is Boolean.

According to an embodiment of the present disclosure, neural network 24 comprises a training input connected to the output of a direction detector of training structure 100. According to an embodiment, the direction detector of training structure 100 is provided for outputting a direction detection signal D1 . . . n upon detection of the direction along which said external force is applied to member 12. According to an embodiment of the present disclosure, the direction detection signal D1 . . . n comprises of a predetermined number of Boolean signals indicating each a predetermined direction of application of said external force relative to the training structure 100, and therefore to the member 12.

According to an embodiment of the present disclosure, the training structure 100 is removably attached to member 12, for example at the distal extremity 60 of Member 12.

According to an embodiment of the present disclosure, in operation the neural network 22 is queried first to determine if an external force is being applied. If the answer is positive, the direction neural network 24 is queried for the force direction.

According to an embodiment of the present disclosure, both neural networks 22 and 24 can be Multi-Layer Perceptrons (MLPs) that comprise each 5 fully connected hidden layers with 100 neurons each. According to an embodiment of the present disclosure, the ReLU activation function (see X. Glorot, A. Bordes, and Y. Bengio, “Deep sparse rectifier neural networks,” in International Conference on Artificial Intelligence and Statistics, 2011, pp. 315-323, hereafter [21]) can be used for all layers. According to an embodiment of the present disclosure, a subsequent output layer can produce pseudo-probabilities using the softmax function.

According to an embodiment of the present disclosure, a time-window approach can be used to obtain the networks' input. The underlying assumption is that although some classification accuracy can be achieved by training only on the time frame for which prediction is requested, better results could be obtained when using information from past frames. Due to the nature of the classification task, the time-window used can be relatively small.

FIG. 2 also illustrates an alternative embodiment of the present disclosure, where the Force and Direction output signals F and D respectively output by the neural networks 22, 24 are provided to an intermediary module 102 capable of transforming Force and Direction output signals F and D into Direction and Velocity commands (Dir; Vel) that can be used by controller 20 to control directly a motion of member 12. According to an embodiment of the present disclosure, robot arm can be an arm known under the commercial name of Stäubli's medium payload arm TX90; controller 20 can be a CS8 controller running a VAL3 control software. Data can be streamed by a LIVE TCP streaming platform (see C. Batliner, J. M. Newsum, and M. C. Rehm, “Live,” in Robotic Futures, P. F. Yuan, A. Menges, and N. Leach, Eds. plus 0.5 em minus 0.4 em Tongji University Press, 2015, hereafter [20]).

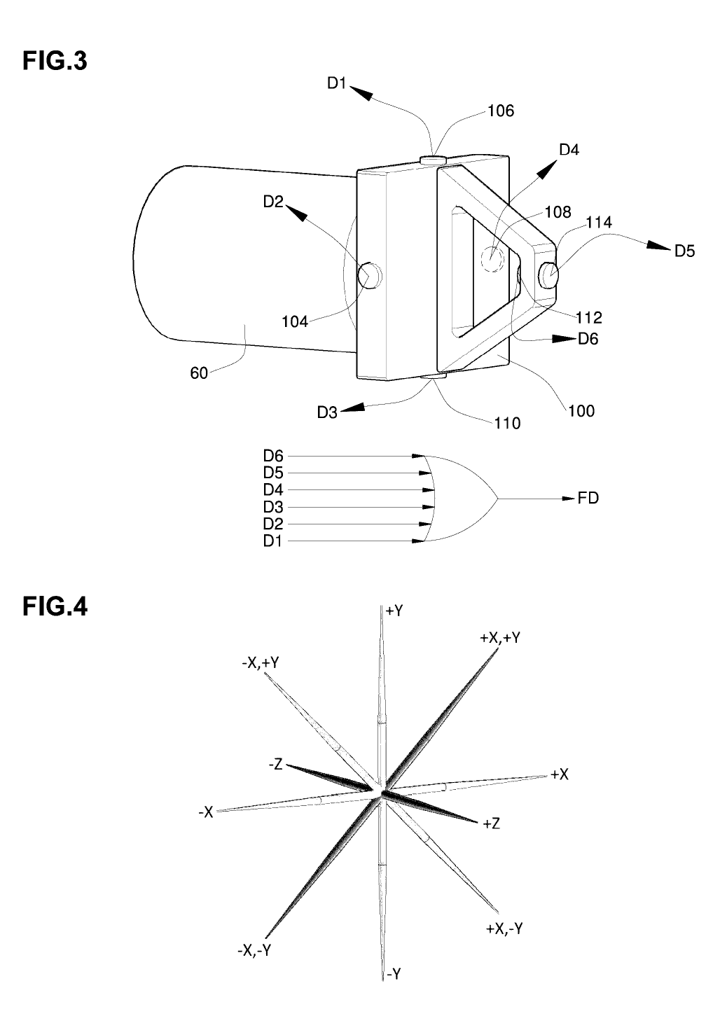

FIG. 3 details training structure 100 attached to the distal end 60 of member 12 according to an embodiment of the present disclosure, provided for outputting a six bit Force Direction signal D1 . . . D6. According to an embodiment of the present disclosure, the direction detector of training structure 100 comprises six push buttons 104, 106, 108, 110, 112, 114 facing each one of six directions X, Y, −X, −Y, Z −Z in a three dimensional XYZ referencial. According to an embodiment of the present disclosure, the pressing of each of push buttons 104, 106, 108, 110, 112, 114 produces a Boolean direction detection signal D1 . . . D6 associated to the direction opposite the direction faced by the push button. According to an embodiment of the present disclosure, the pressing of any of push buttons 104, 106, 108, 110, 112, 114 produces a force detection signal FD. For example, force detection signal can be produced by a logical OR of each of Boolean signals D1 . . . D6.

FIG. 4 illustrates the six directions X, Y, −X, −Y, Z, −Z indicated by signals D1 . . . D6. According to an embodiment of the present disclosure, training structure 100 can be rotated 45 degree around the Z axis so that the push buttons 104, 106, 108 and 110 face directions −X−Y, −X+Y, +X+Y and +X−Y to generate four further bit Force Direction signal D7 . . . D10. In this case, signals D1-D10 are sent to neural network 24 during the training, and force detection signal FD can be produced by a logical OR of Boolean signals D1 . . . D10.

According to an embodiment of the present disclosure, structure 100 can alternatively comprise four more buttons (not shown) facing directions −X−Y, −X+Y, +X+Y and +X−Y, each buttons sending one of boolean signals D1-D10.

According to an embodiment of the present disclosure, neural networks 22 and 24 are trained by:

with the controller, positioning the distal end 60 at any of a number of random positions forming a cloud of random points;

at each position, activating the learning mode of neural network 22 and pressing in sequence each of push buttons 104, 106, 108, 110, 112, 114. As outlined above, the pressing of any of the push buttons result in the sending of a Boolean force detection signal to the neural network 22, and the sending of a Boolean direction detection signal D1 . . . D10 associated to the direction opposite the pressed push button.

Network 22 being in training mode, it establishes neural connections linking the Torque signals T1 . . . T6 and the Angle signals A1 . . . A6 and the existence of a non-null force detection signal.

Network 24 being in training mode, it establishes neural connections linking the Torque signals T1 . . . T6 and the Angle signals A1 . . . A6 and the Boolean direction detection signal.

After networks 22 and 24 have been trained for each random point of the cloud, networks 22 and 24 are switched out of training mode.

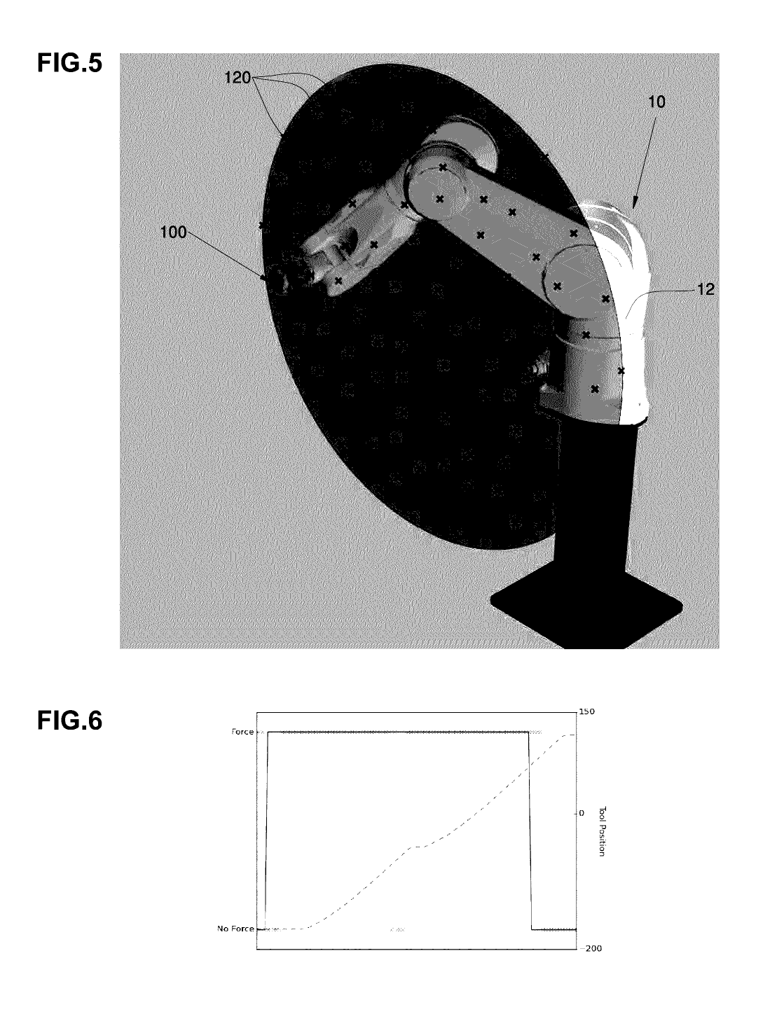

FIG. 5 illustrates an exemplary cloud of random position points 120 to which was moved the training structure 100, removably attached to the distal end 60 of the member 12 of robot 10, during a training of neural networks 22 and 24.

According to an embodiment of the Disclosure, pushing the buttons of structure 100 can be done by hand, which allows for example collecting 747,000 data points in about ten hours. According to an embodiment of the Disclosure, each push action of a button of structure 100 creates multiple samples. Further, that data points are also collected for each training positions when no force is applied.

According to an embodiment of the Disclosure, the neural networks can be implemented using Keras deep learning framework (see F. Chollet, “keras,” https://github.com/fchollet/keras, 2015, hereafter [22]). The training of the neural networks can be done using the Stochastic Gradient Descent method with momentum. Learning rates of 0.1, 0.01, 0.001 can be used, each for 40 epochs. A batch size of 512 and a momentum value of 0.9 can be used. A random subset of 90% of the data can be used as the training set. and a well-separated random subset of 10% can be used as a validation set. The same train/test split can be used for testing multiple network architectures, as detailed in Sec. IV-A.

According to an embodiment of the Disclosure, the neural networks can be implemented using for example: (i) feedforward Multi Layer Perceptrons such as outlined above, or (ii) recurrent networks designed for time series. The neural networks can alternatively be LSTM (Long-Short Term Memory) networks (see S. Hochreiter and J. Schmidhuber, “Long short-term memory,” Neural computation, vol. 9, no. 8, pp. 1735-1780, 1997, hereafter [23], which is a type of recurrent neural network that has been shown to achieve good results in many time-series tasks (see A. Graves and J. Schmidhuber, “Framewise phoneme classification with bidirectional lstm and other neural network architectures,” Neural Networks, vol. 18.5, pp. 602-610, 2005 (hereafter [24]) and F. Gers, “Long Short-Term Memory in Recurrent Neural Networks,” Ph.D. dissertation, Federal Polytechnic School of Lausanne, Department of Computer Science, Lausanne, Switzerland, 2001 (hereafter [25])). In the past, it was demonstrated (see F. A. Gers, D. Eck, and J. Schmidhuber, “Applying LSTM to time series predictable through time-window approaches,” in Artificial Neural Networks—ICANN, plus 0.5 em minus 0.4 em Springer, 2001, pp. 669-676; hereafter [26]) that a time-windowed MLP may perform better than LSTM in some but not all cases.

According to an embodiment of the Disclosure, the neural networks can follow multiple architectures with varying depth and number of hidden units per layer. Note that a hidden unit in an LSTM network contains four times the number of parameters of a hidden neuron in an MLP.

Table I depicts the results obtained for multiple network configurations. In these results, the MLP networks appear to outperform the LSTM ones by a large margin. The results also indicate that detecting the presence of an external force is a more difficult task than distinguishing the force vector. This is despite the former being a binary classification task while the latter is a multiclass one. Note, however, that the error rates in both tasks are rather low, varying from 1.6% to 4.5% for the best network, depending on the task. These numbers are prior to the refinement described hereafter.

According to an embodiment of the Disclosure, the neural networks can be each a network of 5 MLP layers of size 100. Such a neural network has an input vector of size 440. Half of this consists of the raw signals and half contains the difference in values from the last time step. In order to demonstrate the contribution of the second half, Table I also contains the results of a network trained to predicted based solely on the 220 raw signals. This network is significantly outperformed by the network that employs the full input vector.

Table 2 displays a confusion analysis of the errors over the eleven classes: the no-force case and the ten directions. It is clear that the directions are mostly not confused among themselves, and confusion mostly occurs with regards to the presence of a force.

TABLE I
Validation errors of alternative neural networks.

| Method | Force | Direction | Combined |
|---|---|---|---|
| LSTM1L400 (1 × 400) | 0.128 | 0.070 | 0.141 |
| LSTM2L200 (2 × 200) | 0.125 | 0.085 | 0.153 |
| LSTM2L300 (2 × 300) | 0.140 | 0.064 | 0.136 |
| LSTM5L100 (5 × 100) | 0.200 | 0.072 | 0.196 |
| MLP4L (4 × 100) | 0.049 | 0.026 | 0.062 |
| MLP5L (5 × 100) | 0.038 | 0.016 | 0.045 |
| MLP6L (6 × 100) | 0.052 | 0.027 | 0.066 |
| MLP5L_ND (5 × 100) | 0.049 | 0.022 | 0.062 |

LSTM1L400 is an LSTM model with a single layer of size 400. LSTM2L200 is an LSTM model with 2 layers of size 200. LSTM2L300 is a two layer LSTM with layer size 300. LSTM5L100 - five layer LSTM with layer size 100. MLP4L, MLP5L, and MLP6L are MLP networks with layer size 100 and a total of 4, 5 and 6 layers respectively (MLP5L is the network used throughout this work). MLP5L_ND is a five layer MLP with layer size 100 but trained without the signal difference features. Each network was trained for two separate classification tasks, detecting external force existence (‘Force’ column) and classification of input signal to one of the ten direction vectors (‘Direction’ column). The ‘Combined’ column shows the error after combining the output from both networks to a single 11-class label. The values show mean error across the participating classes.

TABLE 2
The confusion matrix of the combined output of the MLP classifier networks. The
row labels are the actual classes; the column headers present the predicted classes.

| | No Force | +X | −Y | −X | +Y | +X, −Y | −X, −Y | −X, +Y | +X, +Y | +Z | −Z |
|---|---|---|---|---|---|---|---|---|---|---|---|
| No | 0.96 | 0.00 | 0.00 | 0.00 | 0.00 | 0.00 | 0.00 | 0.00 | 0.00 | 0.01 | 0.01 |
| Force | | | | | | | | | | | |
| +X | 0.04 | 0.95 | 0.00 | 0.00 | 0.00 | 0.00 | 0.00 | 0.00 | 0.00 | 0.00 | 0.00 |
| −Y | 0.04 | 0.00 | 0.95 | 0.00 | 0.00 | 0.00 | 0.00 | 0.00 | 0.00 | 0.00 | 0.00 |
| −X | 0.04 | 0.00 | 0.00 | 0.95 | 0.00 | 0.00 | 0.00 | 0.00 | 0.00 | 0.00 | 0.00 |
| +Y | 0.03 | 0.00 | 0.00 | 0.00 | 0.95 | 0.00 | 0.00 | 0.00 | 0.00 | 0.00 | 0.00 |
| +X, −Y | 0.02 | 0.00 | 0.00 | 0.00 | 0.00 | 0.97 | 0.00 | 0.00 | 0.00 | 0.00 | 0.00 |
| −X, −Y | 0.03 | 0.00 | 0.00 | 0.00 | 0.00 | 0.00 | 0.97 | 0.00 | 0.00 | 0.00 | 0.00 |
| −X, +Y | 0.02 | 0.00 | 0.01 | 0.01 | 0.00 | 0.00 | 0.00 | 0.96 | 0.00 | 0.00 | 0.00 |
| +X, +Y | 0.02 | 0.00 | 0.00 | 0.01 | 0.00 | 0.00 | 0.00 | 0.00 | 0.96 | 0.00 | 0.00 |
| +Z | 0.06 | 0.00 | 0.00 | 0.00 | 0.00 | 0.00 | 0.00 | 0.00 | 0.00 | 0.94 | 0.01 |
| −Z | 0.05 | 0.00 | 0.00 | 0.00 | 0.00 | 0.00 | 0.00 | 0.00 | 0.00 | 0.00 | 0.94 |

As illustrated in FIG. 2, according to an embodiment of the present disclosure, neural networks 22 and 24 additionally receive a signal xyz indicating a position of the distal end 60 of member 12, for example with respect to the proximal end 62, during training, and during use to generate respectively the force signal F and the direction signal D.

As illustrated in FIG. 2, according to an embodiment of the present disclosure, neural networks 22 and 24 additionally receive a signal alpha indicating a rotation of an axis of the distal end 60 of member 12, for example with respect to the proximal end 62, during training, and during use to generate respectively the force signal F and the direction signal D.

As illustrated in FIG. 2, according to an embodiment of the present disclosure, neural networks 22 and 24 additionally receive a signal SP indicating a speed of the distal end 60 of member 12, for example with respect to the proximal end 62, during training, and during use to generate respectively the force signal F and the direction signal D. A null speed can indicate that the robot is settled.

According to an embodiment of the present disclosure, the two neural networks 22, 24 can be trained on the same input data, composed of the robot readings, available through the robot's API: (i) joint rotation values; (ii) torque values; (iii) flange position, orientation and velocity, plus the force signal for neural network 22 and the direction signal for neural network 24. Specifically, an input of size 440, which is a concatenation of the 11 recent time steps (including the current time step), can be used at each time point. The input data at each time step consists of the following:
6 Torque values—one for each joint
6 Joint rotation values—one for each joint
3 Flange (distal end) location in world coordinates (x,y,z)
3 Flange (distal end) rotation in world coordinates (rx,ry,rz)
1 Flange (distal end) velocity
1 Whether the robot is settled or not.

In addition to the 20 raw signals above, the difference in values from the last time step can added to each data point. This forms a total of 40 features, that can be collected for example at a rate of 25 Hz.

According to an embodiment of the present disclosure, added robustness can be gained by incorporating two simple heuristics that help compensating for the unavoidable gaps between the data collected during the training phase and the actual data seen at deployment.

First, the threshold of the force/no-force neural network 22 can be lowered in order to allow a better action detection rate, at the expense of increasing the number of false positives. This considerably can improve sensitivity of the robot to light touch.

Second, in order to reduce noise, a buffer can store the five previous classifications. The actual classification is taken to be the absolute majority label (if it exists) from that buffer. In other words, if the force neural network 22 predicts the existence of an external force (Boolean signal F at one), the direction of said force is recorded. Out of the last five readings, if for example the same direction was obtained three times, the system recognizes an external force in this direction. Otherwise, the system reports no external force.

The two heuristics operate in different directions: while the first supports more liberal predictions of force, the second is more conservative. The obtained system is reliable with respect to the direction of the motion and is responsive to outside forces. By changing the above parameters, the system's sensitivity and the output direction's reliability can be controlled.

Once a force is detected, the robot can be programmed to move in a constant velocity along the direction of the detected force. The robot can then be moved by push or pull forces applied by hand by an operator to the flange/distal end 60 of member 12.

FIG. 6 illustrates force network 22 output during a push event in the positive X direction. The solid line depicts when a force is being applied to the robot flange; the +ticks depict the classifier output (correct/incorrect) during this period; the dashed line shows the robot flange movement along the X axis. A small lag appears between the actual force and the classifier detecting it, resulting in a corresponding lag in movement response.

FIG. 7 illustrates a method of controlling a robot according to an embodiment of the present disclosure.

The method comprises for controlling a robot having at least one member, said at least one member having at least one controllably actuable articulation:

periodically generating 200 a torque signal indicative of a torque applied to the articulation, and an angle signal indicative of an angle of actuation of the articulation;

with a first neural network receiving 202 the torque and angle signals, generating a force signal indicating that an external force is applied to said at least one member;

with a second neural network receiving 204 the torque and angle signals, generating a direction signal indicating the direction along which said external force is applied to said at least one member; and

modifying 206 a control of said at least one controllably actuable articulation with said force and direction signals.

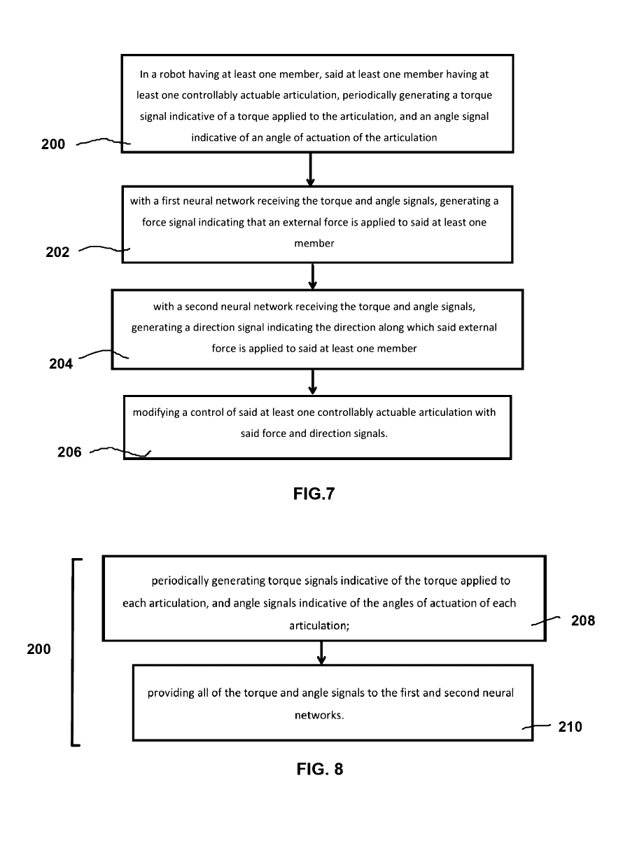

FIG. 8 illustrates an embodiment of the method of FIG. 7, where the robot comprises a plurality of controllable articulations each controlled by the controller; wherein said periodically generating 200 a torque signal indicative of a torque applied to the articulation, and an angle signal indicative of an angle of actuation of the articulation comprises:

periodically generating 208 torque signals indicative of the torque applied to each articulation, and angle signals indicative of the angles of actuation of each articulation; and

providing 210 all of the torque and angle signals to the first and second neural networks.

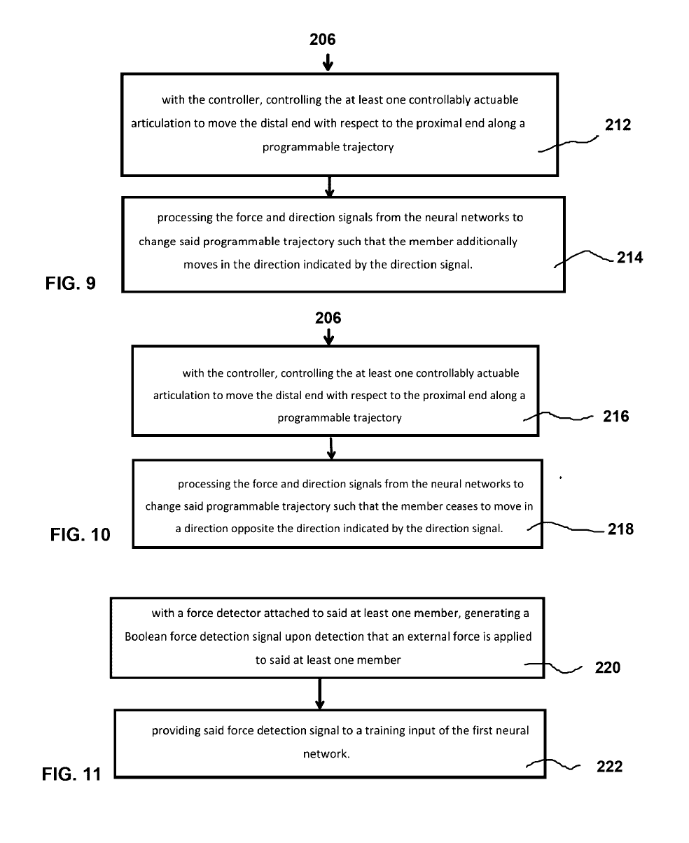

FIG. 9 illustrates steps that can follow the step 206 above where said member comprises a distal end and a proximal end, wherein the method additionally comprises:

with the controller, controlling 212 the at least one controllably actuable articulation to move the distal end with respect to the proximal end along a programmable trajectory; and

processing 214 the force and direction signals from the neural networks to change said programmable trajectory such that the member additionally moves in the direction indicated by the direction signal.

FIG. 10 illustrates steps that can follow the step 206 above where said member comprises a distal end and a proximal end, wherein the method additionally comprises:

with the controller, controlling 216 the at least one controllably actuable articulation to move the distal end with respect to the proximal end along a programmable trajectory; and

processing 218 the force and direction signals from the neural networks to change said programmable trajectory such that the member ceases to move in a direction opposite the direction indicated by the direction signal.

FIG. 11 illustrates a method of programming of the first neural network of a robot according to the present disclosure, wherein the first neural network comprises a training input and wherein the method comprises, with a force detector attached to said at least one member, generating 220 a force detection signal upon detection that an external force is applied to said at least one member; and providing 222 said force detection signal to said training input of the first neural network. According to an embodiment of the present disclosure, said generating a force detection signal comprises generating a Boolean force detection signal.

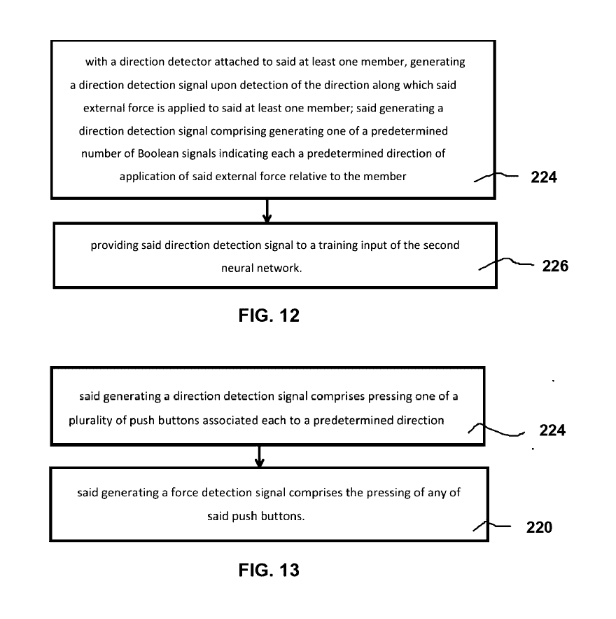

FIG. 12 illustrates a method of programming of the second neural network of a robot according to the present disclosure, wherein the second neural network comprises a training input and wherein the method comprises, with a direction detector attached to said at least one member, generating 224 a direction detection signal upon detection of the direction along which said external force is applied to said at least one member; and providing 226 said direction detection signal to said training input of the second neural network. According to an embodiment of the present disclosure, said generating a direction detection signal comprises generating one of a predetermined number of Boolean signals indicating each a predetermined direction of application of said external force relative to the member.

FIG. 13 illustrates an embodiment of the present disclosure where said generating 224 a direction detection signal comprises pressing one of a plurality of push buttons associated each to a predetermined direction; and wherein said generating 220 a force detection signal comprises the pressing of any of said push buttons.

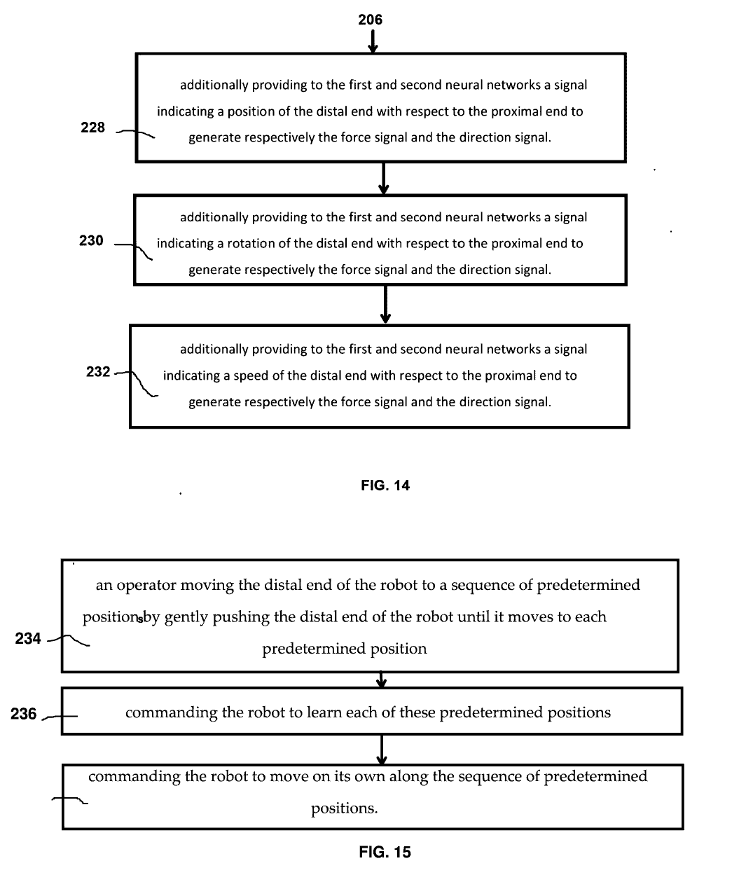

FIG. 14 illustrates steps that can follow the step 206 above, where said member comprises a distal end and a proximal end and where the method further comprises additionally providing 228 to the first and second neural networks a signal indicating a position of the distal end with respect to the proximal end to generate respectively the force signal and the direction signal; and/or

additionally providing 230 to the first and second neural networks a signal indicating a rotation of the distal end with respect to the proximal end to generate respectively the force signal and the direction signal; and/or

additionally providing 232 to the first and second neural networks a signal indicating a speed of the distal end with respect to the proximal end to generate respectively the force signal and the direction signal.

FIG. 15 illustrates a method of training a robot according to an embodiment of the present disclosure, the method comprising an operator moving 228 the distal end of the robot to a sequence of predetermined positions by gently pushing the distal end of the robot until it moves to each predetermined position; commanding 230 the robot to learn each of these predetermined positions, and commanding 232 the robot to move on its own along the sequence of predetermined positions.

While the present Disclosure has been described using specific embodiments, it should be appreciated that the present disclosure should not be construed as limited by such embodiments.

What is claimed is:

1. A robot having at least one member, said at least one member having at least one controllably actuable articulation, said articulation having at least one torque sensor for providing a torque signal indicative of a torque applied to the articulation, and one angle sensor for providing an angle signal indicative of an angle of actuation of the articulation;
the robot further comprising:
a controller for controlling said at least one controllably actuable articulation;
a first neural network arranged for receiving the torque and angle signals and arranged for providing to the controller a force signal indicating that an external force is applied to said at least one member;
a second neural network arranged for receiving the torque and angle signals and arranged for providing to the controller a direction signal indicating the direction along which said external force is applied to said at least one member.

2. The robot of claim 1, having a plurality of controllable articulations each controlled by the controller, each articulation comprising an angle sensor and a torque sensor, wherein the first and second neural networks are arranged for receiving the torque and angle signals from all the articulations, and for providing respectively said force signal indicating that an external force is applied to said at least one member and said direction signal indicating the direction along which said external force is applied to said at least one member.

3. The robot of claim 1, wherein said member comprises a distal end and a proximal end, and wherein the controller is capable of controlling the at least one controllably actuable articulation to move the distal end with respect to the proximal end along a programmable trajectory; and
wherein the processor comprises a trajectory change module that processes the force and direction signals from the neural networks to change said programmable trajectory such that the member additionally moves in the direction indicated by the direction signal as long as the force signal is present.

4. The robot of claim 1, wherein said member comprises a distal end and a proximal end, and wherein the controller is capable of controlling the at least one controllably actuable articulation to move the distal end with respect to the proximal end; and
wherein the processor processes the force and direction signals from the neural networks to move the distal end with respect to the proximal end in the direction indicated by the direction signal as long as the force signal is present.

5. The robot of claim 1, wherein the first neural network comprises a training input; the training input being connected to the output of a force detector; the force detector being attached to said at least one member and being provided for outputting a force detection signal upon detection that an external force is applied to said at least one member.

6. The robot of claim 5, wherein said force detection signal is Boolean.

7. The robot of claim 5, wherein the force detector is removably attached to said at least one member.

8. The robot of claim 5, wherein the second neural network comprises a training input; the training input being connected to the output of a direction detector; the direction detector being attached to said at least one member and being provided for outputting a direction detection signal upon detection of the direction along which said external force is applied to said at least one member.

9. The robot of claim 8, wherein said direction detection signal is one of a predetermined number of Boolean signals indicating each a predetermined direction of application of said external force relative to the member.

10. The robot of claim 8, wherein the direction detector is removably attached to said at least one member.

11. The robot of claim 8, wherein the direction detector comprises one push button associated to each of said predetermined directions, each push button associated to a predetermined direction facing said predetermined direction; wherein the pressing of a push button associated to a predetermined direction produces a direction detection signal associated to said predetermined direction, and wherein the pressing of any push button produces a force detection signal.

12. The robot of claim 1, wherein said member comprises a distal end and a proximal end and wherein the first and second neural networks additionally use a signal indicating a position of the distal end with respect to the proximal end to generate respectively the force signal and the direction signal.

13. The robot of claim 1, wherein said member comprises a distal end and a proximal end and wherein the first and second neural networks additionally use a signal indicating a rotation of the distal end with respect to the proximal end to generate respectively the force signal and the direction signal.

14. The robot of claim 1, wherein said member comprises a distal end and a proximal end and wherein the first and second neural networks additionally use a signal indicating a speed of the distal end with respect to the proximal end to generate respectively the force signal and the direction signal.

15. A method of controlling a robot having at least one member, said at least one member having at least one controllably actuable articulation;
the method comprising:
periodically generating a torque signal indicative of a torque applied to the articulation, and an angle signal indicative of an angle of actuation of the articulation;
with a first neural network receiving the torque and angle signals, generating a force signal indicating that an external force is applied to said at least one member;
with a second neural network receiving the torque and angle signals, generating a direction signal indicating the direction along which said external force is applied to said at least one member; and
modifying a control of said at least one controllably actuable articulation with said force and direction signals.

16. The method of claim 15, wherein the robot comprises a plurality of controllable articulations each controlled by the controller:
wherein said periodically generating a torque signal indicative of a torque applied to the articulation, and an angle signal indicative of an angle of actuation of the articulation comprises periodically generating torque signals indicative of the torque applied to each articulation, and angle signals indicative of the angles of actuation of each articulation;
the method further comprising providing all of the torque and angle signals to the first and second neural networks.

17. The method of claim 15, wherein said member comprises a distal end and a proximal end, and wherein the method further comprises:
with the controller, controlling the at least one controllably actuable articulation to move the distal end with respect to the proximal end along a programmable trajectory; and
processing the force and direction signals from the neural networks to change said programmable trajectory such that the member additionally moves in the direction indicated by the direction signal.

18. The method of claim 15, wherein said member comprises a distal end and a proximal end, and wherein the method further comprises:
with the controller, controlling the at least one controllably actuable articulation to move the distal end with respect to the proximal end along a programmable trajectory; and
processing the force and direction signals from the neural networks to change said programmable trajectory such that the member ceases to move in a direction opposite the direction indicated by the direction signal.

19. The method of claim 15, wherein the first neural network comprises a training input and wherein the method further comprises, with a force detector attached to said at least one member, generating a force detection signal upon detection that an external force is applied to said at least one member; and providing said force detection signal to said training input of the first neural network.

20. The method of claim 19, wherein said generating a force detection signal comprises generating a Boolean force detection signal.

21. The method of claim 19, wherein the second neural network comprises a training input and wherein the method further comprises, with a direction detector attached to said at least one member, generating a direction detection signal upon detection of the direction along which said external force is applied to said at least one member; and providing said direction detection signal to said training input of the second neural network.

22. The method of claim 21, wherein said generating a direction detection signal comprises generating one of a predetermined number of Boolean signals indicating each a predetermined direction of application of said external force relative to the member.

23. The method of claim 21, wherein said generating a direction detection signal comprises pressing one of a plurality of push buttons associated each to a predetermined direction; and wherein said generating a force detection signal comprises the pressing of any of said push buttons.

24. The method of claim 15, wherein said member comprises a distal end and a proximal end and wherein the method further comprises additionally providing to the first and second neural networks a signal indicating a position of the distal end with respect to the proximal end to generate respectively the force signal and the direction signal.

25. The method of claim 15, wherein said member comprises a distal end and a proximal end and wherein the method further comprises additionally providing to the first and second neural networks a signal indicating a rotation of the distal end with respect to the proximal end to generate respectively the force signal and the direction signal.

26. The method of claim 15, wherein said member comprises a distal end and a proximal end and wherein the method further comprises additionally providing to the first and second neural networks a signal indicating a speed of the distal end with respect to the proximal end to generate respectively the force signal and the direction signal.

27. A method of training a robot according to claim 3, the method comprising an operator moving the distal end of the robot to a sequence of predetermined positions by gently pushing the distal end of the robot until it moves to each predetermined position; commanding the robot to learn each of these predetermined positions, and commanding the robot to move on its own along the sequence of predetermined positions.
